(19) United States
(12) Patent Application Publication
(10) Pub. No.: US 2018/0091390 A1
(43) Pub. Date: Mar. 29, 2018

(54) DATA VALIDATION ACROSS MONITORING SYSTEMS

(71) Applicant: CA, Inc., New York, NY (US)

(72) Inventors: Yang Yang, Newton, MA (US); Zubing Robin Qin, Southborough, MA (US); Fei Gu, Newton, MA (US)

(21) Appl. No.: 15/277,983

(22) Filed: Sep. 27, 2016

(51) Int. Cl. H04L 12/26; H04L 29/08

(52) U.S. Cl. CPC H04L 43/04; H04L 67/10; H04L 43/08

(57) ABSTRACT

A data validation system receives sets of performance metrics captured by a first monitoring system and a second monitoring system that are monitoring the same components within a data center. The data validation system pairs each set of performance metrics from the first monitoring system to a set of performance metrics from the second monitoring system that are of the same type and related to a same component. The data validation system then normalizes each of the paired sets of performance metrics so that a similarity score for each of the paired sets can be determined. The similarity score is based on a cosine similarity of a paired set of performance metrics multiplied by a ratio of the average value of each of the paired set of performance metrics.

### BACKGROUND

The disclosure generally relates to the field of computer systems, and more particularly to computer system monitoring and analysis.

A data center monitoring system may include software or hardware, often referred to as agents or probes, which execute on components within a data center to measure performance of the components and report performance measurements to the monitoring system. The measurements may include processor utilization, memory utilization, processor temperature, input/output operations per second, etc. In some systems, the agents measure and report tens or hundreds of performance measurements every second.

### BRIEF DESCRIPTION OF THE DRAWINGS

Aspects of the disclosure may be better understood by referencing the accompanying drawings.

FIG. 1 depicts an example data validation system that determines a similarity of data captured by two different monitoring systems.

FIG. 2 depicts graphs illustrating normalization of two data sets.

FIG. 3 depicts graphs illustrating a data set with high-frequency oscillations that is filtered using the moving average algorithm.

FIG. 4 depicts graphs illustrating pairs of data sets for which a similarity score has been determined.

FIG. 5 depicts a flow chart with example operations for performing data validation of performance measurements.

FIG. 6 depicts an example computer system with a data validation system.

### DESCRIPTION

The description that follows includes example systems, methods, techniques, and program flows that embody aspects of the disclosure. However, it is understood that this disclosure may be practiced without these specific details. For instance, this disclosure refers to validating performance measurements determined by two different monitoring systems within a data center. But aspects of this disclosure can be applied to performing data validation of other time-value pair data, such as financial data. In other instances, well-known instruction instances, protocols, structures and techniques have not been shown in detail in order not to obfuscate the description.

### Terminology

The term “component” as used in the description below encompasses both hardware and software resources. The term component may refer to a physical device such as a computer, server, router, etc.; a virtualized device such as a virtual machine or virtualized network function; or software such as an application, a process of an application, database management system, etc. A component may include other components. For example, a server component may include a web service component which includes a web application component.

The term “agent” as used in the description below to refers to a process or device for monitoring a component. An agent may be program code that executes on resources of a component or may be a hardware probe. An agent monitors a component to measure and report performance measurements, such as available memory, processor load, storage space, network traffic, temperature, etc. A component may be instrumented with an agent by installing a hardware probe on the component or by initiating a process on the component that executes program code for the agent.

Introduction

A data center monitoring system is an essential tool for maintaining and ensuring optimum performance of components within a data center. As a result, performance measurements captured and reported by a monitoring system should be consistent and accurate. To maintain consistency, administrators are often reluctant to upgrade an existing monitoring system without first ensuring that performance measurements captured by a new monitoring system are consistent with and at least as accurate as measurements captured by the existing system. However, validating performance measurements between two monitoring systems is difficult given the multiple types of metrics and the large number of components typically monitored by monitoring systems.

Overview

A data validation system receives sets of performance measurements captured by a first monitoring system and a second monitoring system that are monitoring the same components within a data center. The data validation system pairs each set of performance measurements from the first monitoring system to a set of performance measurements from the second monitoring system that are of the same type and related to a same component. The data validation system then normalizes each of the paired sets of performance measurements so that a similarity score for each of the paired sets can be determined. The similarity score is based on a cosine similarity of a paired set of performance measurements multiplied by a ratio of the average value of each of the paired set of performance measurements. The data validation system uses the similarity scores to determine whether performance measurements are consistent between the two monitoring systems.

Example Illustrations

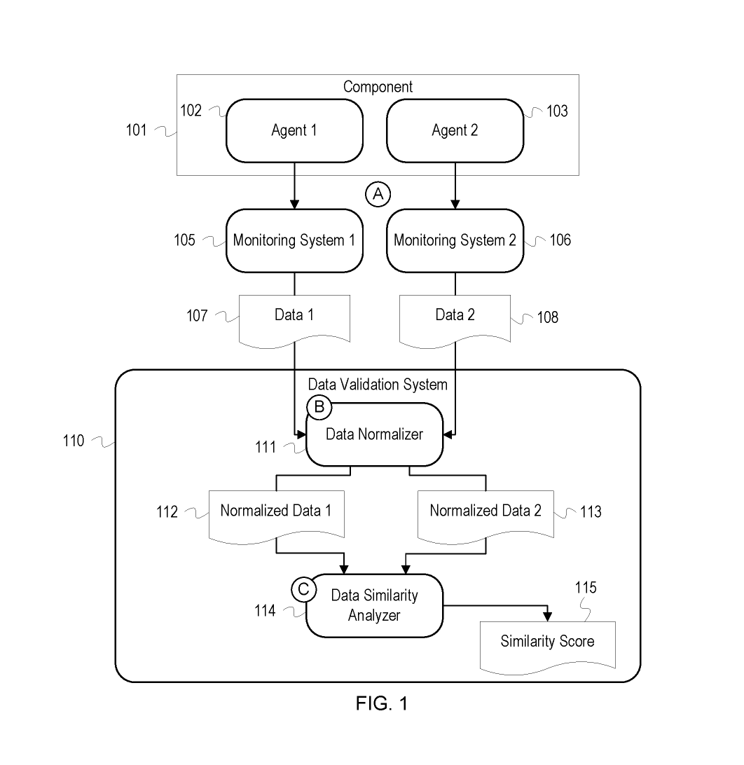

FIG. 1 is annotated with a series of letters A-C. These letters represent stages of operations. Although these stages are ordered for this example, the stages illustrate one example to aid in understanding this disclosure and should not be used to limit the claims. Subject matter falling within the scope of the claims can vary with respect to the order and some of the operations.

FIG. 1 depicts an example data validation system that determines a similarity of data captured by two different monitoring systems. FIG. 1 depicts a component 101, an agent 1 102, and agent 2 103, a monitoring system 1 105, a monitoring system 2 106, and a data validation system 110. The data validation system 110 includes a data normalizer 111 and a data similarity analyzer 114.

At stage A, the agent 102 and the agent 103 monitor the component 101. The component 101 may be one of a variety of hardware resources, such as a host, server, router, switch, database, temperature sensor, etc., or one of a variety of software resources executing on a hardware resource, such as a web server, virtual machine, application, program, process, database management system, etc. The component 101 is instrumented with both the agent 102 and the agent 103 that execute simultaneously to capture performance measurements of the component 101, such as available memory, processor load, storage space, network traffic, temperature, etc. The agent 102 sends captured performance measurements to the monitoring system 1 105, and the agent 103 sends captured performance measurements to the monitoring system 2 106. Because the agent 102 and the agent 103 are part of different monitoring systems, the agents themselves may be different. For example, the agent 102 may be a hardware probe, while the agent 103 is program code. The monitoring system 1 105 and the monitoring system 2 106 collect the performance measurements captured by the agent 1 102 and the agent 2 103 to generate a data 1 107 and a data 2 108 (“the data sets”). The data sets are collections of time-value pairs that indicate the captured performance measurements. The data 1 107 includes data captured by the agent 1 102 and the data 2 108 includes data captured by the agent 2 103 for a same performance metric type.

The monitoring system 1 105 and the monitoring system 2 106 are two different monitoring systems that are each monitoring the component 101 over a same period of time for purposes of performing data validation of data captured by the two monitoring systems. For example, the monitoring system 1 105 may be a legacy monitoring system or an earlier version of a monitoring system that is being replaced by the monitoring system 2 106. Because the monitoring systems are different, the data sets may include different measurements for the same performance metric. Additionally, the granularity or sample rates of the measurements captured by the two monitoring systems may differ, or the times of the measurements will differ. For example, even if the two monitoring systems have a same sample rate, the monitoring systems may begin measuring at two different times resulting in time shifted data sets. As a result, the data sets are sent to the data normalizer 111 to be normalized so that the data sets can be compared and a similarity score determined. The monitoring systems may perform additional processing on the data sets before transmitting the data sets. For example, the monitoring systems may format the measurements in the data sets, add a timestamp for the data set, add an identifier for the component 101, indicate a performance metric type, etc.

At stage B, the data normalizer 111 processes the data 1 107 and the data 2 108 to generate a normalized data 1 112 and a normalized data 2 113. The data normalizer 111 aligns the data sets based on timestamps indicating their start and end times. In some instances, the start and end times may not align. For example, the data 1 107 may include measurements beginning at 2:00 while the measurements in the data 2 108 do not start until 2:05. To align the start time, the data normalizer 111 may duplicate the data point at 2:00 from the data 1 107 to the data 2 108. This allows the data sets to share a data point at a common start time. The data normalizer 111 may similarly add data points to align the end time of the data sets. In some implementations, the data normalizer 111 may find a first point and a last point at which the data sets align and choose those points as the begin and end points for the data sets and disregard data points outside of the time period comprising the first point and the last point. Having a common start and end time allows the data sets to be normalized and a similarity score determined over a common time period.

Once the data sets are aligned at start and end times, the data normalizer 111 normalizes the data sets using sampling and linear interpolation. The data normalizer 111 first determines a sampling rate to be used for normalizing the data sets. If the data sets have a same sample rate, i.e. one data point every 5 seconds, the data normalizer 111 may use the shared sample rate as the sample rate for normalization. In instances where the sample rates do not align, the data normalizer 111 may choose a higher frequency sample rate. For example, the sample rate for the data 1 107 may be one data point every 3 seconds while the sample rate for the data 2 108 is one data point every 2 seconds. In this example, the data normalizer 111 may choose a sample rate of 1 data point every 2 seconds or a higher sample rate such as 1 data point every 1 second. For a 10 second time period with a 2 second sample rate, the data normalizer samples the data sets at 6 different points: at 0 seconds, 2 seconds, 4 seconds, 6 seconds, 8 seconds, and 10 seconds. The sampled data points may not align with the existing data points indicated in the data sets. As a result, the data normalizer 111 uses linear interpolation to determine missing data points for the data sets at the sample times. Linear interpolation is a method of curve fitting using linear polynomials to construct new data points within the range of a discrete set of known data points. One formula for linear interpolation is as follows:

$$y = {y}_{0} + ( {y}_{1} - {y}_{0} ) \frac{x - {x}_{0}}{{x}_{1} - {x}_{0}}$$

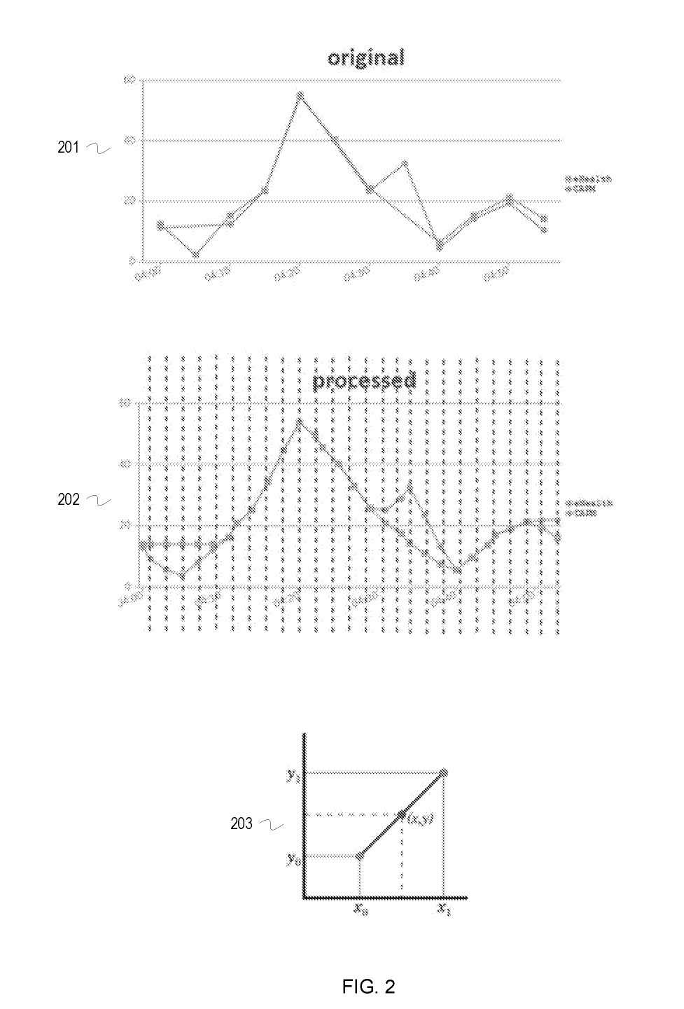

An example of linear interpolation is illustrated in FIG. 2.

In some instances, one or both of the data sets may include data with high-frequency oscillations. For example, processor utilization measurements often include frequently varying data points. The high-frequency oscillations make it difficult to normalize and determine the similarity among the data sets. In such instances, the data normalizer 111 filters one or both of the data sets using a moving average algorithm to generate a smooth data curve that reflects a trend of the oscillating data sets. A moving average is a calculation to analyze data points by creating a series of averages of different subsets of the full data set. Given a series of numbers and a fixed subset size, the first element of the moving average is obtained by taking the average of the initial fixed subset of the number series. Then the subset is modified by “shifting forward;” that is, excluding the first number of the series and including the next number following the original subset in the series. This creates a new subset of numbers, which is then averaged. This process is repeated over the entire data series. One example formula for determining a moving average for a subset of 5 data points is as follows:

$${y}_{3} = \frac{{y}_{1} + {y}_{2} + {y}_{3} + {y}_{4} + {y}_{5}}{5}$$

The example formula above may be used to determine a new value for the data point y₃ that reflects the average of the values surround the data point y₃ (i.e. y₁, y₂, y₄, y₅). As the moving average is shifted forward, a new value may then be determined for the point y₄ using the following formula:

$${y}_{4} = \frac{{y}_{2} + {y}_{3} + {y}_{4} + {y}_{5} + {y}_{6}}{5}$$

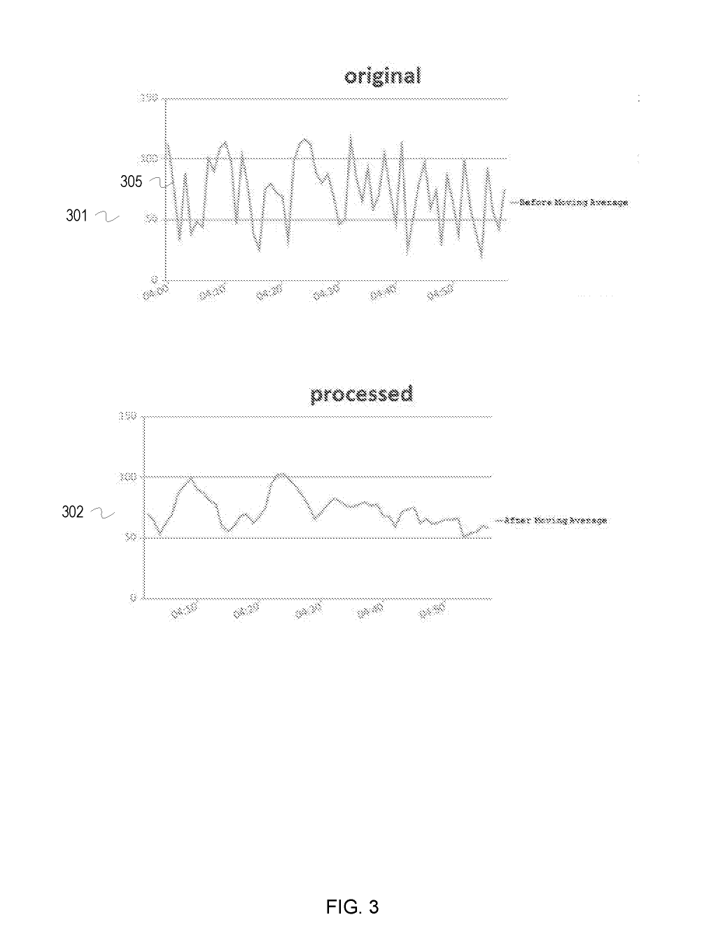

The point y₁ is excluded as the algorithm is shifted forward. In the example formula above, 5 data points are used as a subset of an entire data set to determine a moving average. The number of data points included in the subset can vary based on a total number of data points in a set, a specified granularity, a sampling interval, etc. An example of a moving average is illustrated in FIG. 3.

After a moving average is determined for a data set, the data normalizer 111 may then perform normalization of the data sets using the new data set determined based on the moving average algorithm. In some implementations, the data normalizer 111 may use other filter algorithms to smooth out short-term fluctuations in data sets with high-frequency oscillations, such as a cumulative moving average, a weighted moving average, an exponential moving average, or other finite impulse response filters. After the data sets are normalized, the data normalizer 111 sends the normalized data 1 112 and the normalized data 2 113 to the data similarity analyzer 114.

At stage C, the data similarity analyzer 114 determines a similarity score 115 for the normalized data 1 112 and the normalized data 2 113. The similarity score 115 reflects a degree of similarity between the normalized data 1 112 and the normalized data 2 113 and indicates whether performance measurements captured by the monitoring system 1 105 and performance measurements captured by the monitoring system 2 106 are similar. The similarity score 115 may be indicated as a number between 0 and 1, where 0 indicates completely dissimilar data sets and a 1 indicates identical data sets. The data similarity analyzer 114 determines the similarity score 115 by multiplying a cosine similarity of the two data sets by a ratio of mean values for the two data sets. Cosine similarity is a measure of similarity between two vectors of an inner product space that measures the cosine of the angle between them. In other words, the cosine similarity indicates whether two vectors are similarly oriented. If an angle between two vectors is 0 degrees, this indicates that the two vectors are identically oriented and have a similarity of 1 (cos(0)=1); whereas, if an angle between two vectors is 90 degrees, the two vectors are not similarly oriented and have a similarity of 0 (cos(90)=0). One example formula for determining cosine similarity is as follows:

$$similarity = cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}}$$

In the example formula, the variable A represents a first data set such as the normalized data 1 112, and the variable B represents a second data set such as the normalized data 2 113. The variables Aᵢ and Bᵢ refer to data points within the two data sets.

As described above, the cosine similarity function describes a difference in orientation of two vectors. Cosine similarity does not reflect differences in values. For example, a line indicated by the formula y=x has a cosine similarity of 1 with a line indicated by the formula y=x+1, despite the fact that the formulas have different values at any given x. This is because all vectors within the two lines are similarly oriented. Therefore, cosine similarity alone is not sufficient to indicate similarity between two data sets. To account for differences in values, the cosine similarity is multiplied by a ratio of mean values for the two data sets to determine the similarity score 115. First, a mean average of a first data set, such as the normalized data 1 112, and a mean average of a second data set, such as the normalized data 2 113, are determined. Then, the smaller of the two mean averages is divided by the larger of the mean averages to determine a ratio of the mean values. For example, if the normalized data 1 112 has a mean of 10 and the normalized data 2 113 has a mean of 5, the ratio of the mean values is equal to 5/10 or 0.5. An example formula for the similarity score 115 is as follows:

$$Similarity Score = \frac{A * B}{‖ A ‖ ‖ B ‖} * \frac{Min ( Avg ( A ) , Avg ( B ) )}{Max ( Avg ( A ) , Avg ( B ) )}$$

To avoid obfuscating the description, FIG. 1 depicts a single component, the component 101, and assumes that the data 1 107 and the data 2 108 indicate measurements of a same performance metric type. In some implementations, the monitoring system 1 105 and the monitoring system 2 106 may monitor hundreds or thousands of components. Additionally, agents deployed by the monitoring systems may capture multiple types of performance metrics. In such implementations, the data validation system 110 performs additional steps to reconcile the data sets of performance measurements received from the monitoring system 1 105 and the monitoring system 2 106. The data validation system 110 matches the data sets according to a performance metric type and a component to which the data sets are related. The data validation system 110 may match component identifiers from the data sets as well as identifiers for performance metric types to pair the data sets from the two monitoring systems. In some instances, the monitoring systems may use different formats or nomenclatures for component identifiers and metric type identifiers. In such instances, the data validation system 110 may refer to a table or other data structure that maps the corresponding identifiers to each other.

FIG. 2 depicts graphs illustrating normalization of two data sets. FIG. 2 depicts a graph 201 showing two data sets whose start and end times have been aligned. Also depicted is a graph 202 that illustrates the data sets from the graph 201 after a sampling interval has been determined and linear interpolation has been used to determine the data points at the sample intervals. FIG. 2 also depicts a graph 203 which illustrates an example of linear interpolation.

The graph 201 depicts a first data set of time-value pairs, such as the data 1 107, captured by a first monitoring system and a second data set of time-value pairs, such as the data 2 108, captured by a second monitoring system. The start and end times of the first data set and the second data set have been aligned; however, the data points within the data sets do not exactly align. As a result, sampling and linear interpolation is performed to normalize the two data sets.

The graph 202 illustrates the data sets after sampling and linear interpolation has been performed. The vertical, dashed lines in the graph 202 illustrate the times at which data points are to be sampled from the two data sets for determining similarity. As illustrated by the squares on the data sets in the graph 202, a data point has been determined for the two data sets at each sample time. The data points are determined using the linear interpolation formula described in FIG. 1. Linear interpolation is used to determine an estimated data point based on a line between two known data points. An example of linear interpolation is illustrated in the graph 203. The graph 203 depicts two known data points: (x₀, y₀) and (x₁, y₁). The data point (x, y,) is the data point that was determined using the two known data points and the linear interpolation formula.

FIG. 3 depicts graphs illustrating a data set with high-frequency oscillations that is filtered using the moving average algorithm. FIG. 3 depicts a graph 301 showing a data set 305 that has high-frequency oscillations. FIG. 3 also depicts a graph 302 which shows the data set 305 after the high-frequency oscillations have been smoothed out through filtering.

The graph 301 depicts a data set 305 of time-value pairs that exhibits rapidly changing values, i.e. high-frequency oscillations. As a result, the data set 305 is filtered using the moving average algorithm as described in FIG. 1. The graph 302 reflects the data set 305 after the data set 305 has been filtered.

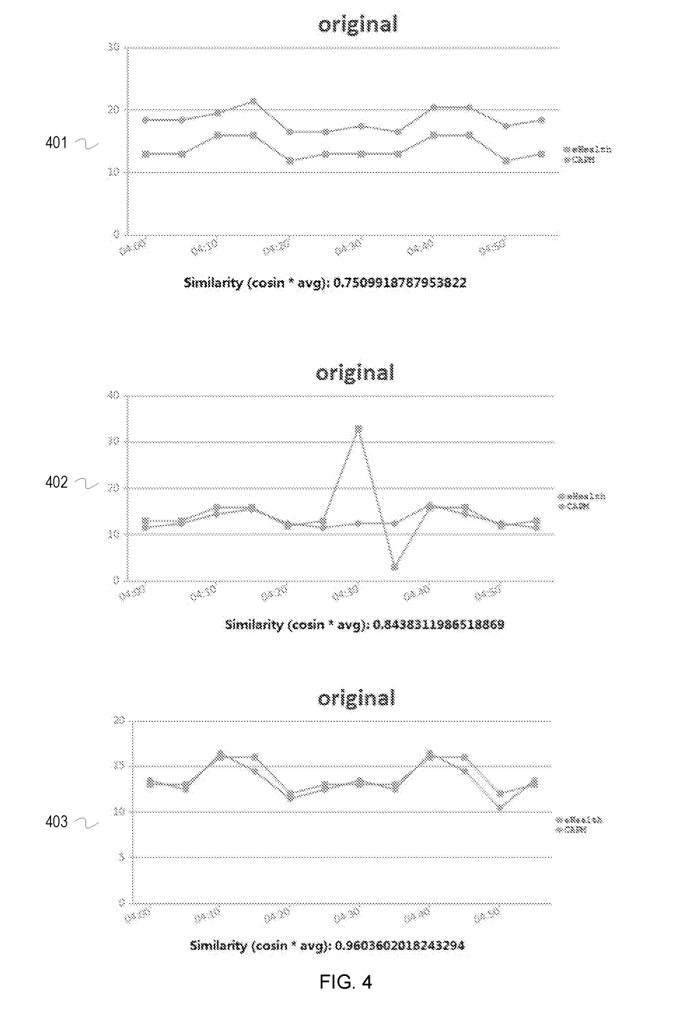

FIG. 4 depicts graphs illustrating pairs of data sets for which a similarity score has been determined. FIG. 4 illustrates a graph 401, a graph 402, and a graph 403. Each of the graphs illustrate pairs of normalized data sets that were captured by two different monitoring systems for a same performance metric at a same component. Depicted below each graph is a similarity score for the pairs of data sets that was determined using the formula described in FIG. 1. The graph 401 indicates the lowest similarity score, i.e. these data sets are the least similar of the illustrated examples. The graph 402 indicates a higher similarity score despite the differences in the middle of the data sets. Finally, the graph 403 indicates the highest similarity score.

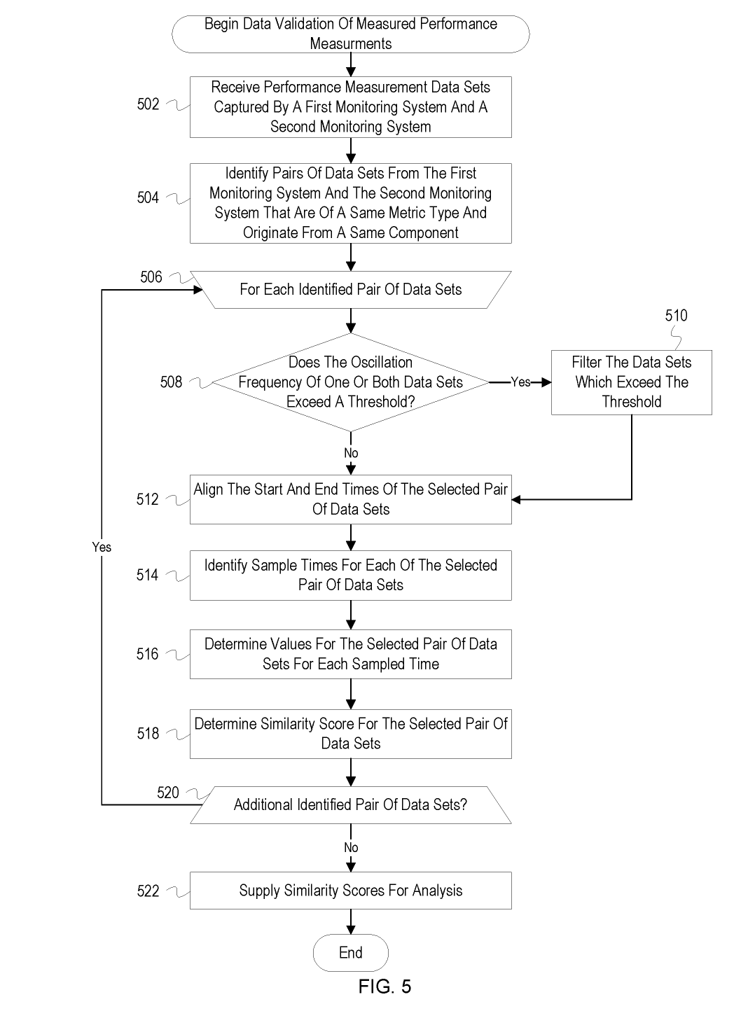

FIG. 5 depicts a flow chart with example operations for performing data validation of performance measurements. FIG. 5 refers to a data validation system similar to the data validation system 110 described in FIG. 1 as performing the operations even though identification of program code can vary by developer, language, platform, etc.

A data validation system (“system”) receives performance metric data sets captured by a first monitoring system and a second monitoring system (502). The performance metric data sets are time-value pairs captured by agents of the first and second monitoring systems executing on a plurality of components. The agents execute on each of the plurality of components and capture measurements of a plurality of metric types, such as available memory, processor utilization, bandwidth, etc. The agents transmit the measurements back to their respective monitoring system. The first and second monitoring systems transmit the metric data sets to the data validation system so the system can determine whether the two monitoring systems are capturing similar measurements. The similarity determination may be beneficial during a testing or performance analysis phase of the first and second monitoring systems. The first and second monitoring system may transmit the data sets in an extensible markup language file, an array, a list, or other suitable data structure. The data structures may include metadata to indicate an identifier for a component to which the data set relates and a type of metric indicated in the data set.

The system identifies pairs of the performance metric data sets that are of a same performance metric type and originate from a same component (504). The system analyzes each the performance metric data sets received from the first and second monitoring systems to determine to which component a data set relates and a type of metric indicated in the data set. For example, the system may determine that a data set relates to or originated from a web server component and indicates a bandwidth type performance metric. The system may determine an identifier for a component and an identifier for the type of metric from metadata associated with the data set by the corresponding monitoring system. The system matches data sets from the first monitoring system to data sets from the set monitoring system that are of the same type and relate to the same component.

The system begins performing data validation for each of the identified pair of data sets (506). The pair of data sets currently being validated is hereinafter referred to as “the selected pair of data sets.”

The system determines whether the oscillation frequency of one or both of the data sets in the selected pair of data sets exceed a threshold (508). The threshold may be a sample rate (e.g. a number of data points/per second), a standard deviation, or an acceptable cumulative amount of change over a specified time period. If the threshold is a sample rate, the system determines whether either of the selected pairs of data sets includes a higher sample rate or more data points per second than the sample rate indicated in the threshold. If the threshold is a standard deviation, the system determines the standard deviation of each of the data sets and compares it to the standard deviation indicated in the threshold. In some implementations, the threshold may be an acceptable cumulative amount of change over a specified time period. For example, the threshold may indicate that values in a data set should not change by more than 40 over a one second period. The system adds up the change in data points over each one second interval in the data set to determine whether the cumulative change exceeds the threshold. For example, a first one second period may include three data points with values of 10, 40, and 20, which is a cumulative change of 50 ((40−10)+(40−20)). In this example, the system determines that the data set exceeds the threshold and, therefore, is a data set with high-frequency oscillation. The system may include thresholds for each performance metric type, such as available storage, temperature, etc.

If the system determines that the oscillation frequency of one or both of the data sets in the selected pair of data sets exceed the threshold, the system filters the data set(s) that exceeds the threshold (510). The system filters the data set(s) which exceeded the threshold using the moving average algorithm as described in FIG. 1. In some implementations, the system may use other data smoothing or curve fitting algorithms. The filtered data set(s) is then used in place of the original data set when normalized the data sets and determining a similarity score.

If the system determines that the oscillation frequency of neither of the selected pair of data sets exceeds the threshold or after the system filters the data set(s) which exceeded the threshold, the system aligns the start and end times of the selected pair of data sets (512). The system may analyze the selected pair of data sets to identify a first data point that occurs at a common time and a last data point that occurs at a common time for each of the data sets. In some implementations, if one data set begins before the other data set, the system may duplicate data points from the set which begins first to the other set for the initial time period to allow the two data sets to have a common start time. The system may similarly duplicate data points at the end of the data sets to allow for a common end time.

The system identifies sample times for each of the selected pair of data sets (514). The system determines a sample rate to be used for normalization of the data sets. The system may use a specified sample rate or may determine a sample rate based on the sample rate of each of the two data sets. In general, the system uses a sample rate that is equal to or exceeds the higher sample rate of the selected pair of data sets. For example, if a first data set has a sample rate of 1 data point per second and a second data set has a sample rate of 2 data points per second, the system uses a sample rate at least equal to 2 data points per second. The system uses the sample rate to determine the times at which the selected pair of data sets will be sampled. The system may begin at the common start time and determine each additional sampled time based on the sample rate until the end of the data sets. For example, if the sample rate is 1 data point every five seconds and the data sets are 20 seconds long, the system determines the sample times to be 0, 5, 10, 15, and 20.

The system determines values for the selected pair of data sets for each determined sample time (516). The system analyzes the selected pair of data sets to determine whether the data sets have data points that correspond to each of the determined sample times. If the data sets do not have data points for each of the determined sample times, the system uses linear interpolation to determine values at the sample times for which the selected pair of data sets do not have a data point. The determined values may be referred to as normalized values for the selected pair of data sets.

The system determines a similarity score for the selected pair of data sets (518). The system determines a similarity score using the normalized values for the selected pair of data sets as described in FIG. 1. In some implementations, the system may determine whether the similarity score falls below a threshold. For example, the system may determine whether the similarity score is less than 0.5. If the similarity score is below the threshold, the system may reprocess the selected pair of data sets using different parameters and then determine a similarity score again based on the reprocessed data sets. For example, the system may adjust the threshold for determining whether a data set has high-frequency oscillations, may determine a different start and end time for the data sets, or adjust the sample rate used during normalization of the selected pair of data sets to a higher or lower resolution. If the similarity score of the reprocessed data sets still falls below the threshold, the system may again reprocess the data sets a specified number of times with different parameters before recording a final similarity score.

The system determines whether there is an additional identified pair of data sets (520). If there is an additional pair of data sets, the system selects the next pair of data sets (506).

If there is not an additional pair of data sets to be validated, the system supplies the similarity scores for analysis (522). The system may display the similarity scores in a sorted list to allow a user to easily identify pairs of data sets with low or high similarity scores. In some implementations, the system may perform further analysis on pairs of data sets with similarity scores below a threshold. For example, the system may determine whether any of the pair of data sets have consistent differences, such as a constant difference in value, that may indicate a programming error. The system may provide the similarity scores and any additionally determined feedback to one or both of the monitoring systems. The monitoring systems may then use machine learning to iteratively adjust algorithms for capturing performance measurements based on increased or decreased similarity scores for each of the measurements.

The data validation system may also indicate an overall similarity or consistency between the two monitoring systems based on the similarity scores. For example, the data validation system may average all of the similarity scores for the pairs of data sets to determine an overall similarity of the two monitoring systems.

Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 514 and 516 of FIG. 5 can be performed in parallel or concurrently. Additionally, the operations depicted in blocks 508 and 510 of FIG. 5 may not be performed. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

Some operations above iterate through sets of items, such as pairs of performance metric data sets. In some implementations, pairs of data sets may be iterated over according to an ordering of the pairs of data sets, metric types indicated in the data sets, a time the data sets were received, etc. Also, the number of iterations for loop operations may vary. Different techniques for normalizing and determining similarity scores for pairs of data sets may require fewer iterations or more iterations. For example, multiple pairs of data sets may be processed in parallel or may share similar data points.

The variations described above do not encompass all possible variations, implementations, or embodiments of the present disclosure. Other variations, modifications, additions, and improvements are possible.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

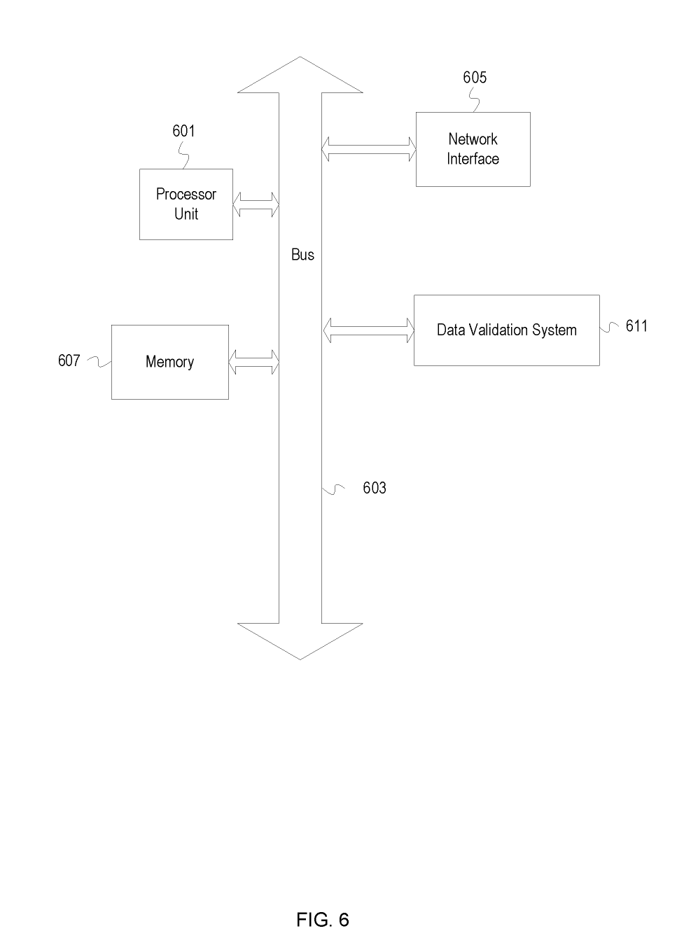

FIG. 6 depicts an example computer system with a data validation system. The computer system includes a processor unit 601 (possibly including multiple processors, multiple cores, multiple nodes, and/or implementing multi-threading, etc.). The computer system includes memory 607. The memory 607 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 603 (e.g., PCI, ISA, PCI-Express, HyperTransport® bus, InfiniBand® bus, NuBus, etc.) and a network interface 605 (e.g., a Fiber Channel interface, an Ethernet interface, an internet small computer system interface, SONET interface, wireless interface, etc.). The system also includes a data validation system 611. The data validation system 611 validates measurements captured by two monitoring systems. Any one of the previously described functionalities may be partially (or entirely) implemented in hardware and/or on the processor unit 601. For example, the functionality may be implemented with an application specific integrated circuit, in logic implemented in the processor unit 601, in a co-processor on a peripheral device or card, etc. Further, realizations may include fewer or additional components not illustrated in FIG. 6 (e.g., video cards, audio cards, additional network interfaces, peripheral devices, etc.). The processor unit 601 and the network interface 605 are coupled to the bus 603. Although illustrated as being coupled to the bus 603, the memory 607 may be coupled to the processor unit 601.

While the aspects of the disclosure are described with reference to various implementations and exploitations, it will be understood that these aspects are illustrative and that the scope of the claims is not limited to them. In general, techniques for data validation between two monitoring systems as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
receiving, from a first agent of a first monitoring system, a first set of measurements captured by the first agent at a first device;
receiving, from a second agent of a second monitoring system, a second set of measurements captured by the second agent at the first device, wherein the first set of measurements and the second set of measurements are of a similar metric type; and
verifying consistency between the first monitoring system and the second monitoring system, wherein verifying consistency between the first monitoring system and the second monitoring system comprises determining a similarity score for the first set of measurements and the second set of measurements.

2. The method of claim 1, wherein determining the similarity score for the first set of measurements and the second set of measurements comprises:
determining a cosine similarity of the first set of measurements and the second set of measurements;
determining a ratio of a first average of the first set of measurements and a second average of the second set of measurements; and
multiplying the cosine similarity by the ratio.

3. The method of claim 2, wherein determining the ratio of the first average of the first set of measurements and the second average of the second set of measurements comprises:
determining whether the first average is greater than the second average;
based on determining that the first average is greater than the second average, determining the ratio to be equal to the second average divided by the first average; and
based on determining that the first average is less than the second average, determining the ratio to be equal to the first average divided by the second average.

4. The method of claim 1 further comprising normalizing the first set of measurements and the second set of measurements.

5. The method of claim 4, wherein normalizing the first set of measurements and the second set of measurements comprises:
determining a set of times at which to sample the first set of measurements and the second set of measurements;
performing linear interpolation using existing data points in the first set of measurements to determine data points for the first set of measurements for each time in the set of times; and
performing linear interpolation using existing data points in the second set of measurements to determine data points for the second set of measurements for each time in the set of times.

6. The method of claim 5, wherein determining the similarity score for the first set of measurements and the second set of measurements comprises determining the similarity score using the data points determined for the first set of measurements and the data points determined for the second set of measurements at the set of times.

7. The method of claim 4, wherein normalizing the first set of measurements and the second set of measurements comprises:
determining that an oscillation frequency of the first set of measurements exceeds a threshold; and
based on determining that the oscillation frequency of the first set of measurements exceeds the threshold, filtering the first set of measurements to smooth out short-term fluctuations in the first set of measurements.

8. The method of claim 7, wherein filtering the first set of measurements to smooth out short-term fluctuations in the first set of measurements comprises filtering the first set of measurements using a moving average algorithm.

9. The method of claim 1 further comprising, based on a determination that the similarity score for the first set of measurements and the second set of measurements is below a threshold, indicating that the second set of measurements captured by the second agent of the second monitoring system are inaccurate, wherein the first monitoring system is an existing monitoring system that is to be updated to the second monitoring system.

10. One or more non-transitory machine-readable media comprising program code for validating data captured by two monitoring systems, the program code to:
receive, from a first agent of a first monitoring system, a first set of measurements captured by the first agent at a first device;
receive, from a second agent of a second monitoring system, a second set of measurements captured by the second agent at the first device, wherein the first set of measurements and the second set of measurements are of a similar metric type; and
verify consistency between the first monitoring system and the second monitoring system, wherein the program code to verify consistency between the first monitoring system and the second monitoring system comprises program code to determine a similarity score for the first set of measurements and the second set of measurements.

11. The non-transitory machine-readable media of claim 10, wherein the program code to determine the similarity score for the first set of measurements and the second set of measurements comprises program code to:
determine a cosine similarity of the first set of measurements and the second set of measurements;
determine a ratio of a first average of the first set of measurements and a second average of the second set of measurements; and
multiply the cosine similarity by the ratio.

12. An apparatus comprising:
a processor; and
a machine-readable medium having program code executable by the processor to cause the apparatus to,
receive, from a first agent of a first monitoring system, a first set of measurements captured by the first agent at a first device;
receive, from a second agent of a second monitoring system, a second set of measurements captured by the second agent at the first device, wherein the first set of measurements and the second set of measurements are of a similar metric type; and
verify consistency between the first monitoring system and the second monitoring system, wherein the program code executable by the processor to cause the apparatus to verify consistency between the first monitoring system and the second monitoring system comprises program code executable by the processor to cause the apparatus to determine a similarity score for the first set of measurements and the second set of measurements.

13. The apparatus of claim 12, wherein the program code executable by the processor to cause the apparatus to determine the similarity score for the first set of measurements and the second set of measurements comprises program code executable by the processor to cause the apparatus to:
determine a cosine similarity of the first set of measurements and the second set of measurements;
determine a ratio of a first average of the first set of measurements and a second average of the second set of measurements; and
multiply the cosine similarity by the ratio.

14. The apparatus of claim 13, wherein the program code executable by the processor to cause the apparatus to determine the ratio of the first average of the first set of measurements and the second average of the second set of measurements comprises program code executable by the processor to cause the apparatus to:
determine whether the first average is greater than the second average;
based on a determination that the first average is greater than the second average, determine the ratio to be equal to the second average divided by the first average; and
based on a determination that the first average is less than the second average, determine the ratio to be equal to the first average divided by the second average.

15. The apparatus of claim 12 further comprising program code executable by the processor to cause the apparatus to normalize the first set of measurements and the second set of measurements.

16. The apparatus of claim 15, wherein the program code executable by the processor to cause the apparatus to normalize the first set of measurements and the second set of measurements comprises program code executable by the processor to cause the apparatus to:
determine a set of times at which to sample the first set of measurements and the second set of measurements;
perform linear interpolation using existing data points in the first set of measurements to determine data points for the first set of measurements for each time in the set of times; and
perform linear interpolation using existing data points in the second set of measurements to determine data points for the second set of measurements for each time in the set of times.

17. The apparatus of claim 16, wherein the program code executable by the processor to cause the apparatus to determine the similarity score for the first set of measurements and the second set of measurements comprises program code executable by the processor to cause the apparatus to determine the similarity score using the data points determined for the first set of measurements and the data points determined for the second set of measurements at the set of times.

18. The apparatus of claim 15, wherein the program code executable by the processor to cause the apparatus to normalize the first set of measurements and the second set of measurements comprises program code executable by the processor to cause the apparatus to:
determine that an oscillation frequency of the first set of measurements exceeds a threshold; and
based on a determination that the oscillation frequency of the first set of measurements exceeds the threshold, filter the first set of measurements to smooth out short-term fluctuations in the first set of measurements.

19. The apparatus of claim 18, wherein the program code executable by the processor to cause the apparatus to filter the first set of measurements to smooth out short-term fluctuations in the first set of measurements comprises program code executable by the processor to cause the apparatus to filter the first set of measurements using a moving average algorithm.

20. The apparatus of claim 12 further comprising program code executable by the processor to cause the apparatus to, based on a determination that the similarity score for the first set of measurements and the second set of measurements is below a threshold, indicate that the second set of measurements captured by the second agent of the second monitoring system are inaccurate, wherein the first monitoring system is an existing monitoring system that is to be updated to the second monitoring system.
